(19) United States
(12) Patent Application Publication
(10) Pub. No.: US 2025/0289065 A1
(43) Pub. Date: Sep. 18, 2025

(54) Huntsman Bit

(71) Applicant: Christopher Neil Cagle, Denton, TX (US)

(72) Inventor: Christopher Neil Cagle, Denton, TX (US)

(21) Appl. No.: 19/221,248

(22) Filed: May 28, 2025

(51) Int. Cl. B23B 51/00

(52) U.S. Cl. CPC B23B 51/009

(57) ABSTRACT

The Huntsman Bit is a Forstner-style drill bit designed to precisely enlarge existing holes, even when a center alignment point is no longer present. It features a non-cutting leading edge that acts as a self-aligning guide within a previously drilled hole, preventing lateral drift and protecting the material surface. Positioned above the guide is a step-cutting edge that incrementally increases the hole diameter with control and accuracy. Constructed from durable steel alloy, the bit is offered in both SAE and metric sizes, with diameters consistent with standard Forstner bit ranges. The design enables versatile application in woodworking and carpentry where reliable hole enlargement is required.

### BACKGROUND OF THE INVENTION

Conventional Forstner bits are prized for their ability to create flat-bottomed, clean holes in wood with minimal splintering. However, they rely on a central point for positioning, making them ineffective at enlarging existing holes where the center has already been removed. This often results in bit slippage, inaccurate cuts, and damage to the workpiece. Woodworkers are thus forced to adopt imprecise or workaround methods to resize holes, reducing efficiency and risking material waste. A need exists for a bit that retains the precision of a Forstner while enabling safe and accurate enlargement of pre-drilled holes, without requiring a center point.

### SUMMARY OF THE INVENTION

The Huntsman Bit solves the enlargement problem inherent in standard Forstner bits by incorporating a non-cutting guide ring at its leading edge, allowing stable insertion into existing holes. Above this guide is a step-cutting edge that progressively enlarges the diameter with precision. This dual-function design merges the clean-cutting benefits of a Forstner with the step-drilling capability found in other bit types. Manufactured from a durable steel alloy, the Huntsman Bit is made available in both SAE and metric sizing, spanning a range that reflects the most commonly used diameters for Forstner bits, while leaving room for expansion beyond traditional sizes. The tool is suited for cabinetry, door modification, and other woodworking applications where refinement and control are essential.

### BRIEF DESCRIPTION OF THE DRAWINGS

FIG. 1 is a front elevation view of the Huntsman Bit.

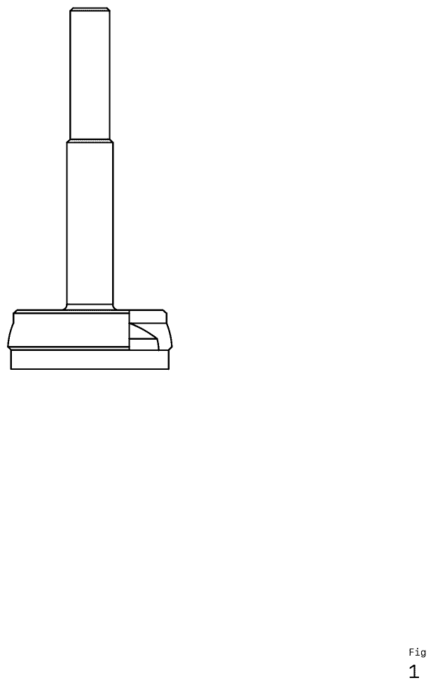

FIG. 2 is a right-side elevation view.

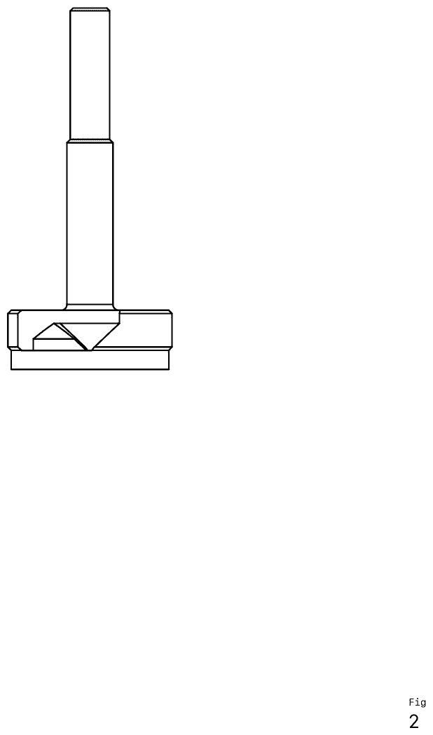

FIG. 3 is a left-side elevation view.

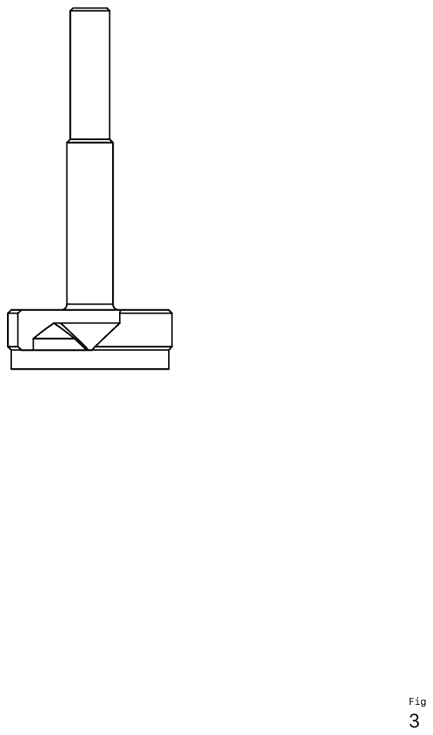

FIG. 4 is a bottom plan view.

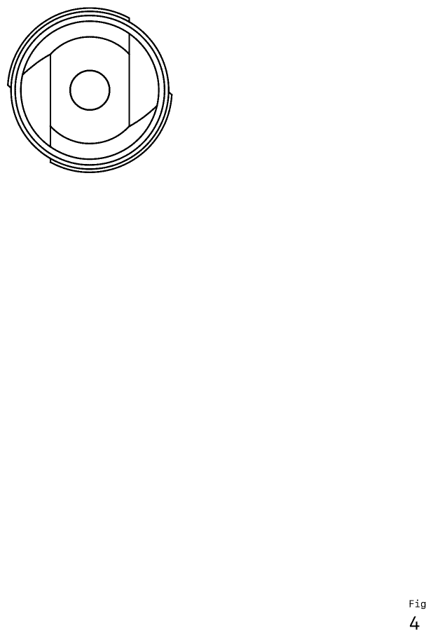

FIG. 5 is a bottom-right isometric perspective view.

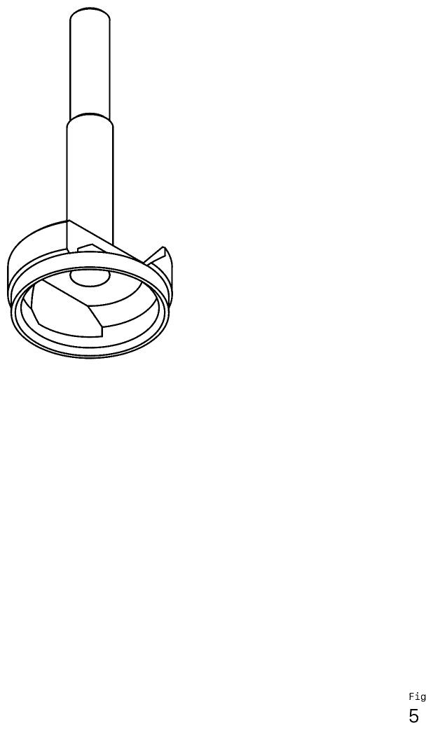

FIG. 6 is a bottom-left isometric perspective view.

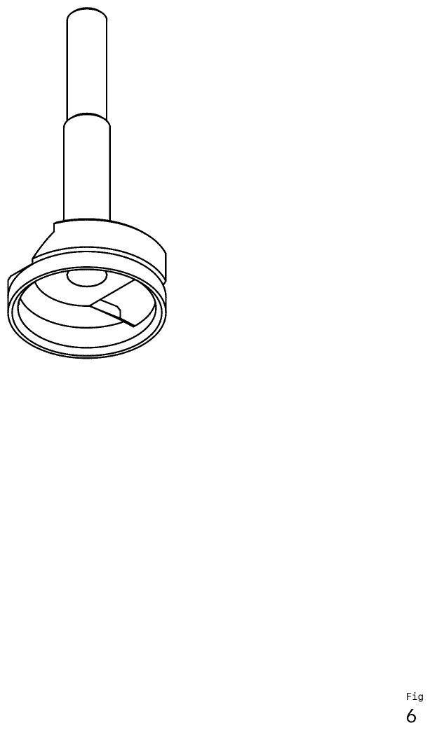

FIG. 7 is a top plan view.

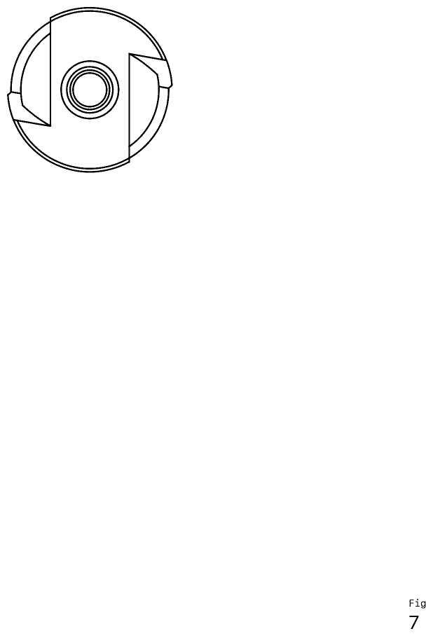

FIG. 8 is a top-right isometric perspective view.

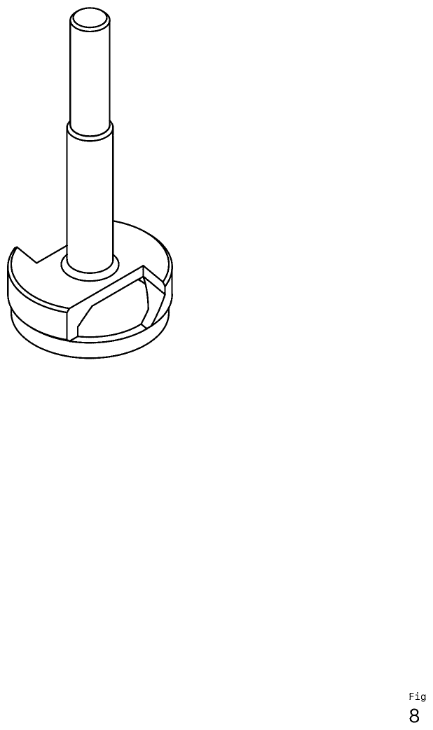

FIG. 9 is a top-left isometric perspective view.

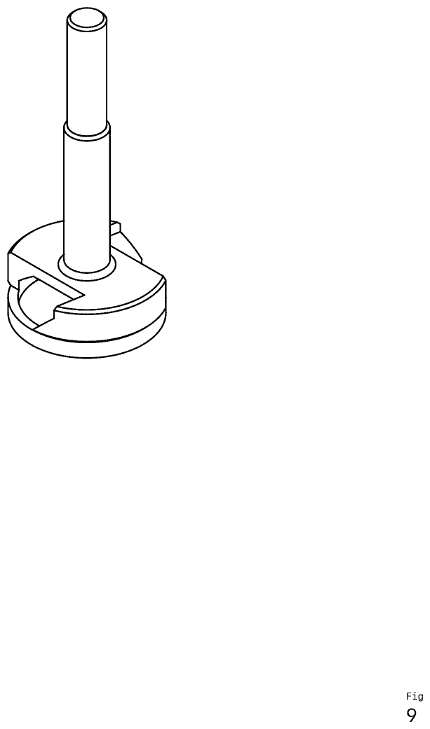

### DETAILED DESCRIPTION OF THE INVENTION

The Huntsman Bit is a specialty drill bit designed for the precise enlargement of existing circular holes, particularly in woodworking and carpentry applications. It is based on the Forstner bit design but incorporates a unique structural enhancement that enables controlled cutting without the need for a central alignment point.

The body of the bit is composed of a high-strength steel alloy suitable for heat treatment, machining, and mass production. The overall length of each bit in the series is standardized, with a preferred length of approximately 3 7/16 inches, though other lengths may be manufactured to accommodate specific tooling requirements.

The cutting diameter of the bit is available in both SAE and metric units, with a range corresponding to standard Forstner bit diameters. In SAE, this typically spans from ¼″ to 2⅛″, with 1/16″ increments. In metric, diameters range from approximately 6 mm to 54 mm in 1 mm or 2 mm increments. However, the invention is not limited to these dimensions and may be manufactured in custom sizes.

The primary feature of the Huntsman Bit is the non-cutting guide ring located at the leading end of the bit. This ring is dimensioned to fit within the interior of a pre-existing hole, maintaining concentricity and alignment during cutting. It has a slightly smaller diameter than the cutting edge above it and may be chamfered, conical, stepped, or rounded to facilitate insertion into rough-edged holes. In alternate embodiments, the guide ring may also incorporate a low-friction insert or polymer coating to minimize resistance during use.

Directly above the guide ring is the step-cutting edge. This sharpened annular rim defines the actual cutting diameter and removes material radially from the existing hole wall. It may include one or more radial flutes or reliefs to evacuate chips and reduce friction. The step edge may also be designed with smooth, toothed, or serrated geometries to optimize performance based on material type or desired cutting aggressiveness.

The shank of the bit is cylindrical and designed for compatibility with standard chucks and drill presses. In preferred embodiments, the shank may include round, hex, or quick-change features. Flattened or grooved sections may also be used to enhance grip and reduce slippage, particularly in handheld power tools or CNC equipment.

In alternate embodiments, the bit may be manufactured from tool steel, carbide, or composite materials. Optional coatings such as titanium nitride, black oxide, or diamond-like carbon (DLC) may be applied to improve wear resistance and reduce heat buildup during extended use. Although the primary application is woodworking, the bit may be adapted for use in plastics, soft metals, or composite materials with appropriate modifications to material and geometry.

In use, the operator selects a Huntsman Bit with the desired final hole diameter, or as part of a series of enlargements to achieve that effect, aligns the guide ring with the existing hole, and applies downward force while rotating the bit with a compatible drill or press. The guide stabilizes the bit and centers it, while the step edge enlarges the hole cleanly and uniformly without damaging the surrounding material or work surface.

Critically, the guide ring is designed to rest within the existing hole without penetrating or disturbing the bottom surface of the material. This enables the user to maintain a flat-bottomed hole-an essential feature in cabinetry, hinge mortising, and other applications where material punch-through must be avoided. The vertical offset between the guide and cutting edge is minimal and engineered to engage only the sidewalls of the hole, not the base. This feature distinguishes the Huntsman Bit from conventional step drill bits, which typically require full-through cuts and cannot maintain such clean bottom finishes.

This design is particularly beneficial for field modifications, cabinetry retrofits, door adjustments, and any application where existing cutouts must be resized with accuracy. Multiple bits may be sold individually or in step-sized kits for progressive enlargement across a range of hole sizes.

1. A drill bit for enlarging an existing hole in a workpiece, comprising:
(a) a cylindrical body having a shank end and a cutting end;
(b) a non-cutting guide ring located at the cutting end, dimensioned to fit within a pre-existing hole and maintain concentric alignment during drilling;
(c) a step-cutting edge located proximally above the guide ring, defining an outer diameter greater than the guide ring and configured to remove material from the sidewalls of the pre-existing hole;
(d) wherein the drill bit is constructed from a durable metal and is dimensioned in accordance with standard SAE and/or metric diameters commonly associated with Forstner bits.

2. The drill bit of claim 1, wherein the body is constructed from a steel alloy, carbide, or composite material.

3. The drill bit of claim 1, further comprising a surface coating selected from the group consisting of titanium nitride, black oxide, or diamond-like carbon (DLC).

4. The drill bit of claim 1, wherein the step-cutting edge includes at least one radial flute to facilitate chip evacuation.

5. The drill bit of claim 1, wherein the guide ring is chamfered, rounded, stepped, or conical in shape.

6. The drill bit of claim 1, wherein the guide ring includes a low-friction polymer sleeve or insert.

7. The drill bit of claim 1, wherein the shank is selected from the group consisting of round, hex, or quick-change configurations.

8. The drill bit of claim 1, wherein the bit is configured for use in wood, plastic, soft metals, or composite materials.

9. A set comprising a plurality of the drill bits of claim 1, each having a different cutting diameter arranged in stepwise increments.

10. The drill bit of claim 1, wherein the guide ring is dimensioned and positioned to rest within the pre-existing hole without extending beyond the original bottom surface of the hole, thereby enabling enlargement of the hole while preserving a flat-bottomed profile.

11. The drill bit of claim 1, wherein the vertical offset between the guide ring and the step-cutting edge is configured such that the guide ring does not extend beyond the existing bottom surface of the pre-drilled hole, thereby maintaining a flat-bottomed profile after enlargement.
